(19) United States
(12) Patent Application Publication
(10) Pub. No.: US 2010/0117853 A1
(43) Pub. Date: May 13, 2010

(54) INFRA-RED (IR) DECODING CIRCUIT

(75) Inventor: Yefim Vayl, Carmel, IN (US)

Correspondence Address: FLETCHER YODER P.C., 7915 FM 1960 RD. WEST, SUITE 330, HOUSTON, TX, 77070, US

(73) Assignee: TTE TECHNOLOGY, INC., Indianapolis, IN (US)

(21) Appl. No.: 12/529,003

(22) PCT Filed: Apr. 18, 2007
(86) PCT No.: PCT/US07/09581

§ 371 Date: Aug. 27, 2009

(51) Int. Cl. G08C 17/02

(52) U.S. Cl. 340/825.57

(57) ABSTRACT

The disclosed embodiments relate to an electronic device configured to receive a control signal. The electronic device comprises a first decoder configured to decode the control signal when the electronic device is operating in a first power mode, and a second decoder configured to decode a first packet in the control signal and discard subsequent packets in the control signal when the video unit is operating in a second power mode.

### FIELD OF THE INVENTION

The present invention relates to infra-red (IR) decoders used in electronic devices, such as televisions (TVs), digital versatile video recorders (DVDRs), video cassette recorders (VCRs), personal digital assistants (PDAs), video cameras, cell phones and so forth.

### BACKGROUND OF THE INVENTION

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Electronic devices, such as those mentioned above, may be controlled remotely by a remote device, typically, known as a remote control. A remote control conveniently enables a user to access the electronic device from a distance so that the user may, for example, change settings and configurations of the electronic device otherwise requiring the user to physically access the electronic device. Controlling the electronic device from a distance is achieved by transmission of IR burst/signals from the remote control to the electronic device. Such IR bursts contain encoded information corresponding to commands and/or functions prompting the electronic device to execute user-desired functionalities. Upon reception by the electronic device, the IR signals transmitted by the remote control undergo processing by dedicated circuitry and/or software disposed within the electronic device so as to decode the information contained in the IR signals. Thereafter, the decoded information may be forwarded to a main processor of the electronic device so that the commands and/or functions may be executed accordingly.

Commands and/or functions decoded by an IR decoder may include, for example, decoding a command received from the remote control turning the electronic device on. Further, when the electronic device is off, most of the device's functionalities are idle. However, certain components within the electronic device must remain on even when the device is turned off so that IR decoding of commands, such as switching the electronic device on, may be enabled. Current implementations of IR decoders, such as those having capabilities mentioned above, require running dedicated software code. Running such software routines may require powering the electronic device's main processor at periods of time when the device is turned off. Consequently, in such periods of time, which can be relatively long at times, the main processor of the electronic device may consume large amounts of electrical power of which only a small amount is actually necessary to implement IR decoding for switching the electronic device on. As a result, much power is wasted when the electronic device is idle, potentially rendering the electronic device non-compliant with industry standards.

### SUMMARY OF THE INVENTION

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

The disclosed embodiments relate to an electronic device configured to receive a control signal (for example, an infra-red (IR) signal). The electronic device comprises a first decoder configured to decode the control signal when the electronic device is operating in a first power mode. The electronic device further comprises a second decoder configured to decode a first packet in the control signal and discard subsequent packets in the control signal when the electronic device is operating in a second power mode.

### BRIEF DESCRIPTION OF THE DRAWINGS

Advantages of the invention may become apparent upon reading the following detailed description and upon reference to the drawings in which:

FIG. 1 is a schematic diagram of a remotely operated electronic device in accordance with an exemplary embodiment of the present invention;

FIG. 2 is schematic diagram of an IR decoder circuit in accordance with an exemplary embodiment of the present invention;

FIG. 3 is a detailed schematic diagram of the IR decoder circuit of FIG. 2 in accordance with an exemplary embodiment of the present invention; and

FIG. 4 is a flow chart of a method of operation of an IR decoder in accordance with an exemplary embodiment of the present invention.

### DETAILED DESCRIPTION OF THE PREFERRED EMBODIMENT

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

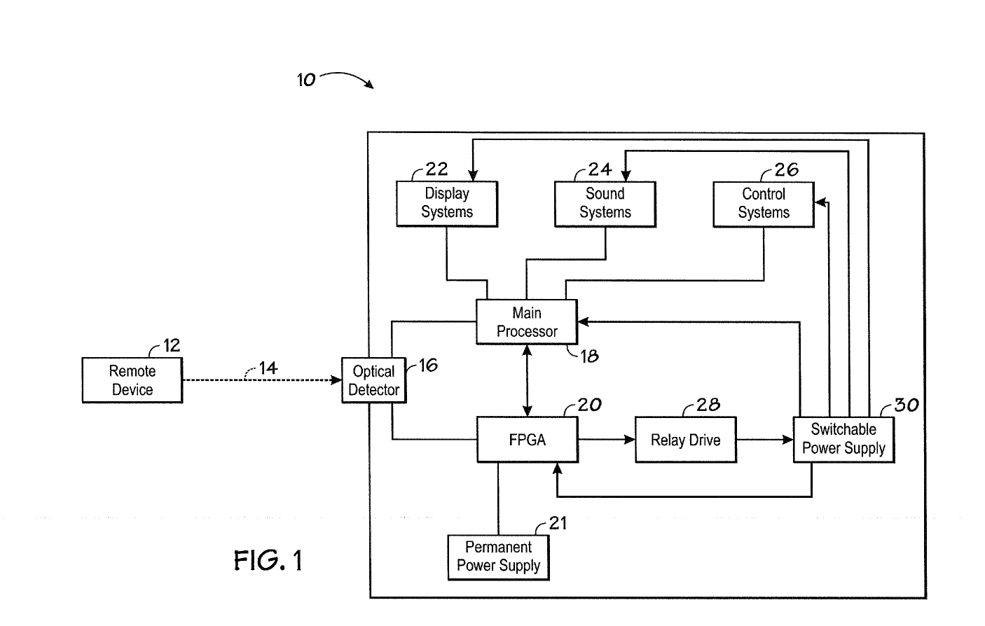

FIG. 1 is a schematic diagram of a remotely operated electronic device 10 in accordance with an exemplary embodiment of the present invention. The electronic device 10 may be a TV, computer, DVDR, VCR, PDA, video cameras, cell phone or the like. The device 10 is controlled by a remote device 12, such as a remote control, configured to transmit IR signals 14 to the electronic device 10. The IR signals 14 emitted by the remote control 12 encode various operational commands and functions enabling, for example, a user to switch the device 10 on and off, change the channels of the device 10 and/or control other settings and features of the device 10, that is, features and configurations normally incorporated in the previously mentioned electronic devices.

As further depicted in FIG. 1, the electronic device 10 is formed of various circuits, devices, software and the like adapted to intercept, process and execute incoming IR signals emitted by the remote control 12. Accordingly, the electronic device 10 is comprised of an optical detector 16, such as a photodetector, adapted to receive the IR signals 14 and convert such IR signals into electrical signals so that these may be forwarded for processing by additional hardware of the electronic device 10. The electronic device 10 further includes a main processor 18 and field programmable gate arrays (FPGA) 20, both of which may be connected to the detector 16. The main processor 18 may be coupled to other systems included in the electronic device 10, including display systems 22, sound systems 24 and control systems 26. When the electronic device 10 is fully operational, i.e., turned on, the main processor 18 receives and processes encoded IR commands that control the systems 22-26. For example, where the electronic device 10 is a TV, main processor 18 may process certain commands received from the remote control 12 to control the TV's brightness and/or sound pitch as provided by the display and sound systems 22 and 24, respectively. Where the electronic device is, for example, a VCR the main processor 18 may process rewind and forward commands received by the remote control 12 to prompt the control system 26 for operating the rewinding/forwarding wheel of the VCR accordingly.

In an exemplary embodiment of the present invention, the FPGA 20 is formed of programmable logic blocks and programmable interconnects typically comprising semiconductor devices. The FPGA 20 may be programmable to emulate the functionality of basic logic gates such as AND, OR, XOR, NOT or more complex combinational functions such as decoders or math functions. The FPGA 20 may also include memory elements, which may be simple flip-flops or complete blocks of memory. In the illustrated embodiment, main processor 18 and FPGA 20 is adapted to implement an IR decoder whose functionality is split between the main processor 18 and the FPGA 20 when the electronic device is turned on/off, respectively. Such a hardware implementation of an IR decoder enables the electronic device 10 to consume low amounts of power while it is turned off. While in the illustrated embodiment the FPGA 20 is shown as a separate component from main processor 18, other embodiments may have FPGA 20 incorporated with the main processor. It should further be noted that the FPGA 20 may be adapted to perform numerous operations, many of which may be active during periods of time when the electronic device is turned on and, some of which may be unrelated to the operation of the present IR decoder.

The FPGA 20 is coupled to a permanent power supply 21 configured to supply constant power to the FPGA 20 during their operation. During periods of time in which the device 10 is turned off and low power mode FPGA IR decoding is enabled, permanent power supply 21 provides the low but sufficient power to those components of the FPGA 20 implementing IR decoding. When the device 10 is turned on, switchable power supply 30 may provide additional power to the FPGA 20 to enable their complete operation.

The electronic device 10 further includes a relay drive 28 connected to the FPGA 20 and to a switchable power supply 30. The switchable power supply 30 is connected to the main processor 18. During periods of time in which the electronic device 10 is turned on, the switchable power supply 30 is configured to supply power to the main processor 18, as well as to other systems contained within the electronic device 10, such as the systems 20 and 22-26. Similarly, during periods of time when the electronic device 10 is off, no power is delivered to the main processor 18 and to the systems 22-26 as the power supply 30 is disconnected from those components. Such switching capabilities of power supply 30 are controlled by the relay drive 28.

The components of the electronic device 10, as described above, form an IR decoder whose function is split between the FPGA 20 and the main processor 18. Such a splitting occurs as the device 10 transitions between on/off states. For example, when device 10 is switched off remotely, the remote control 12 emits the IR signals 14 which are intercepted by the detector 16 and are forwarded as electrical signals to the main processor 18 and to the FPGA 20. Such IR signals encode a command to disconnect the main processor 18 and systems 22-26 from the switchable power supply 30 while powering portions of the FPGA 20 configured to function as the IR decoder when the electronic device 10 is switched off. Accordingly, circuit blocks within the FPGA 20 designated for IR decoding are adapted to consume low amounts of power such that the overall consumption of power by the electronic device 10, when switched off, is low as well. As a result, such a configuration may render the electronic device 10 compliant with industry standards, one of which is known as “Energy Star,” an industry standard requiring electronic devices employing IR decoders to consume low amounts of power.

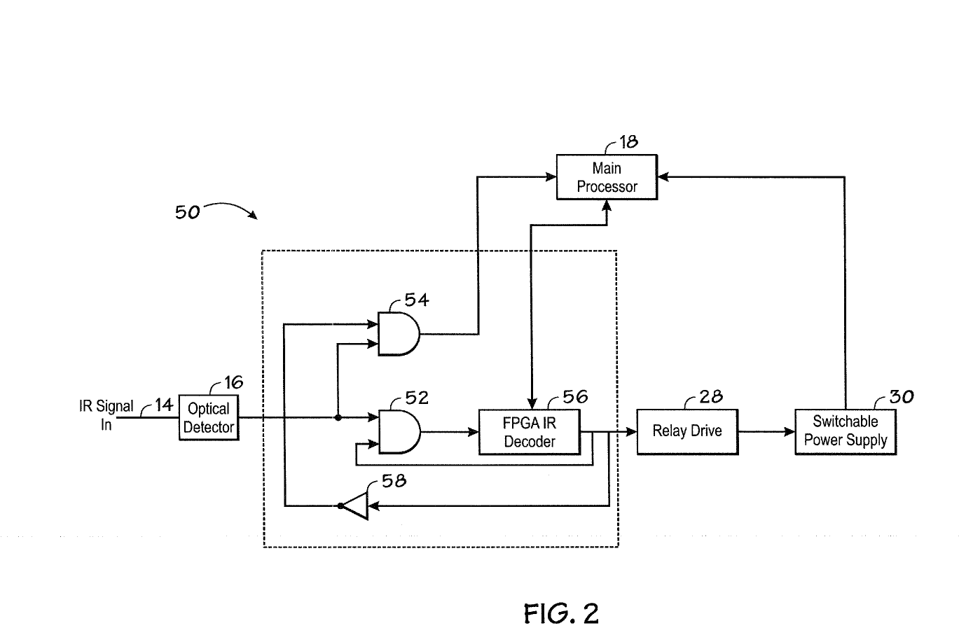

Similarly, when the electronic device 10 is switched on, the remote control 12 emits IR signals 14 encoding commands and/or functions to enable the relay drive 28 to connect the switchable power supply 30 to the main processor 18, while providing additional power to the FPGA 20. At that time, the main processor 18 may take over all IR decoding function for decoding commands and/or functions received from the remote control 12 when the electronic device 10 is switched on. Those of ordinary skill in the art will appreciate that implementing FPGA IR decoding, as described below in FIG. 2, requires no additional hardware and/or software in addition to what is normally included in electronic devices, such as those mentioned above. Thus, to the extent that existing FPGA (e.g., FPGA 20) of an electronic device (e.g., electronic device 10) is configurable for IR decoding, the present technique does not require any additional components to be added to the electronic device 10.

FIG. 2 is a schematic diagram of an IR decoder circuit 50 in accordance with an exemplary embodiment of the present invention. In the illustrated embodiment, the circuit 50 is part of an FPGA of an electronic device, such as the FPGA 20 of electronic device 10 of FIG. 1. As further depicted by FIG. 2, the circuit 50 may be coupled to additional components described above with regard to the electronic device 10. Such components include the detector 16, main processor 18, relay drive 28 and switchable power supply 30.

Generally, the circuit 50 includes AND gates 52 and 54, an FPGA IR decoder 56 and an inverter 58. An input of each of the AND gates 52 and 54 is coupled to the output of the detector 16. The output of AND gate 54 is provided as an input to the main processor 18. The output of AND gate 52 is provided as an input to the FPGA IR decoder 56. The output of the FPGA IR decoder 56 is provided to the relay drive 28 and to the main processor 18. Further, an inverter 58 is coupled between FPGA IR decoder 56/relay drive 28 and the AND gate 54. The relay drive 28 is coupled to the switchable power supply 30, which in turn is coupled to the main processor 18.

When implemented in an electronic device, such as the electronic device 10 of FIG. 1, the circuit 50 splits IR decoding functionality between the FPGA 20 and the main processor 18. In accordance with the present technique, when the device 10 is switched off, it is set to a low power mode in which only the circuit 50 may be operable within electronic device 10. In such a mode, the circuit 50 maintains the relay drive in an “off” state such that the main processor 18 and systems 22-26 (FIG. 1) are disconnected from the switchable power supply 30. As a result, incoming IR signals are intercepted by the detector 16 and are routed to AND gates 52 and 54. Because the main processor is disconnected from the power supply 30 when the circuit 50 is placed in the “off” state, incoming IR signals 14 are processed by the AND gate 52 and, thereafter, by the FPGA IR decoder 56.

Further processing of the incoming IR signals 14 entails parsing those signals into what are known as a “preamble” portion and a “command” portion, where each portion typically comprises a certain number of bits, such as 12, 24, etc. The FPGA IR decoder 56 is adapted to compare the bits of the preamble and/or command of the IR signal to predefined values stored in a look-up table (LUT) included in the FPGA IR decoder 56. Such comparison determines whether bit-values of the command and/or preamble match the predefined values of the LUT which may be a precondition for changing the power mode of the circuit 50. For example, a matching between the “command” and the predefined value stored on the LUT of the FPGA IR decoder 56 produces a signal switching the relay drive 28 to an “on” state, whereby the power supply 30 powers the main processor 18 so that it may be fully operational. However, if no matching exists between the “command” and the LUT, the relay drive remains in an “off” state.

By the same token, a matching of the “preamble” to a LUT stored on the FPGA IR decoder 56 produces a signal that is routed, via inverter 58, to gate 54 to be further processed by the main processor 18. At this point, the electronic device operates at a full power mode in which the main processor 18 takes full control over IR decoding, while the circuit 50 is idle. When the electronic device 10 is turned off, as dictated by a certain “command” and/or a “preamble” processed by the main processor 18, the relay drive 28 may be set to an “off” state, thereby disconnecting the power supply 30 from the main processor 18 and activating circuit 50.

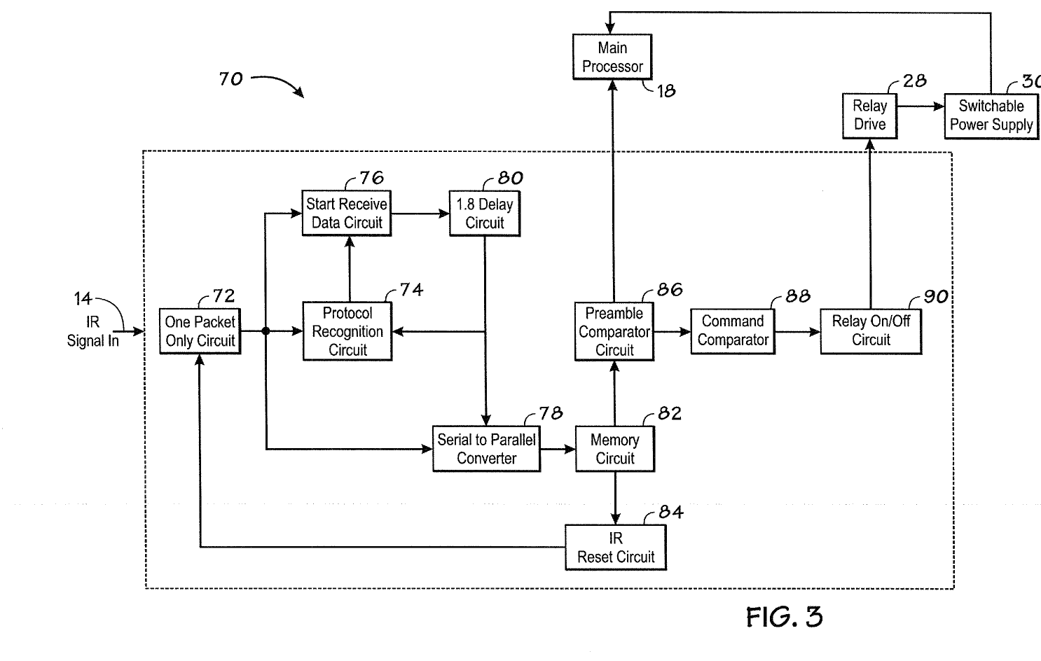

FIG. 3 is a detailed schematic diagram of an IR decoder circuit 70 similar to the IR decoder circuit 50 of FIG. 2, in accordance with an exemplary embodiment of the present invention. The circuit 70 is configured to process incoming IR signals when the electronic device 10 is in a low power mode. The circuit 70 may be formed of electronic components such as circuits including field programmable gate arrays, such as the FPGA 20 disposed within the electronic device 10 of FIG. 1. The FPGA IR decoding circuit 70 provides a hardware implementation of IR decoding otherwise requiring various software implementations and capabilities for decoding IR signals. Furthermore, the FPGA IR decoding circuit 70 is configured to consume low amounts of power, thus maintaining the electronic device 10 in compliance with a standard such as the Energy Star standard. As described further below, the circuit 70 includes a number of sub-circuits each configured to carry out designated operations for decoding received IR signals. Such sub-circuits are formed of logic gates performing various logic operations in accordance with IR decoding operations.

As will be appreciated by those having ordinary skill in the art, IR signals/bursts contain multiple packets formed of bits encoding specific commands and/or functions. Generally, during transmission of such IR signals a user may unintentionally transmit multiple packets of bits forming duplicates of one another. Accordingly, the circuit 70 includes circuit 72, labeled “one packet only circuit,” configured to extract only one packet for further processing, while discarding the other duplicate packets. In so doing, the circuit 70 avoids processing identical multiple packets repeatedly thereby increasing its efficiency. The output of circuit 72 is provided as an input to circuits 74-78. Circuit 74 is a protocol recognition circuit configured to recognize whether the incoming IR signals correspond to given known protocols. Such protocols may specify IR signal bit composition, ordering, etc., in accordance with a remote control specification. Further, the output of circuit 74 is provided to the circuit 76, labeled “a start receive data circuit,” configured to initiate reception of IR signals once protocol recognition is verified. Circuit 78, labeled “serial to parallel converter circuit” converts the encoded incoming IR signals 14, comprised of serial or consecutive portions, into parallel portions. For example, such portions may be known as “command” and/or “preamble,” each having a designated function in encoding various operations executable by the circuit 70 and/or by the main processor 18.

The circuit 76 is further coupled to a delay circuit 80 configured to generate a delay time interval before the received IR signal data is converted from a serial form to a parallel form, as performed by the circuit 78. The circuit 78 is coupled to a memory circuit 82 configured to store information encoded within the IR signal, such as the “command” and/or “preamble” portions. The memory circuit 82 is further coupled to a reset circuit 84 and to a preamble comparator circuit 86. The reset circuit 84 is configured to reset the circuit 70 between consecutive IR decoding processes and is, therefore, coupled to circuit 72. The preamble comparator circuit 86 is configured to compare bits comprising the “preamble” portion of the IR signal to predefined values stored in a look-up table (LUT) included in the comparator 86. The preamble comparator 86 is coupled to the main process 18 and to the command comparator 88. Similar to the comparator 86, the command comparator 88 is adapted to compare bits comprising the “command” portion of the IR signal to predefined “command” values stored in a look-up table (LUT) included in the comparator 88. As mentioned above, comparisons made by the preamble and/or command comparators 86 and 88, respectively, produce desired signals leading to changes of the logic state of the circuit 70 as the electronic device transitions between high and low power modes.

The “command” comparator 88 is coupled to a relay on/off circuit 90 adapted to switch the relay drive 28 between “on” and “off” states. Accordingly, the relay on/off circuit 90 is coupled to the relay drive 28, which is further coupled to the switchable power supply 30. As in FIG. 2 the switchable power supply 30 is also coupled to the main processor 18.

As previously mentioned, the FPGA IR decoding circuit 70 is configured to function as an IR decoding circuit when the electronic device 10 is in a low power mode. Accordingly, when the electronic device 10 operates in a low power mode, incoming IR signals are processed by the circuit 70. Such low power mode IR processing may enable the relay drive 28 in connecting the switchable power supply 30 to the main processor 18 as the electronic device is turned on. In so doing, the logic state of the circuit 70 changes as IR decoding capabilities of the electronic device 10 are transferred from the circuit 70 to the main processor 18.

As an overview of the operation of the FPGA IR decoding circuit 70, when the electronic device 10 is in low power mode, the circuit 70 initially processes incoming IR signals utilizing circuit 72. The circuit 72 ascertains a single data packet from a plurality of identical data packets comprising the IR signal transmitted by the remote control 12 (FIG. 1). Accordingly, the circuit 72 discards remaining data packets while forwarding the single data packet for further processing by the circuit 70.

The data packet then undergoes “Mark/Space” protocol recognition by the circuit 74, such that when properly recognized the data packet is permitted to undergo further processing by additional elements forming the circuit 70. Hence, after the delay imposed by the circuit 80, the circuit 78 converts the data packet from a serial form to a parallel form.

Thereafter, the data packet is stored in the memory circuit 82. Once the data packet is saved, the reset circuit 84 resets the circuit 70 so as to prepare the circuits 72-80 for processing subsequent IR data packets.

Once saved in the circuit 82, the data packet is further processed by circuits 86 and 88 whereby portions of the data packet are parsed into a “preamble” portion and a “command” portion, respectively. Moreover, the circuits 86 and 88 compare the “command” and “preamble” portions to respective predefined values stored in look-up tables (LUTs) contained within the circuits 86 and 88. Accordingly, obtaining a match between the “preamble” portion of the data packet and the LUT of circuit 86 results in a signal that is forwarded to the main processor 18 indicative of preamble matching. Similarly, obtaining a match between the “command” portion and the LUT of circuit 88 produces a signal prompting the circuit 90 to enable the relay drive 28 to electrically connect the switchable power supply 30 to the main processor 18. At that point, the circuit 70 becomes idle and the main processor 18 acquires all IR decoding functionalities as the electronic device is switched from a low power consuming mode to a high power consuming mode, such as an on state.

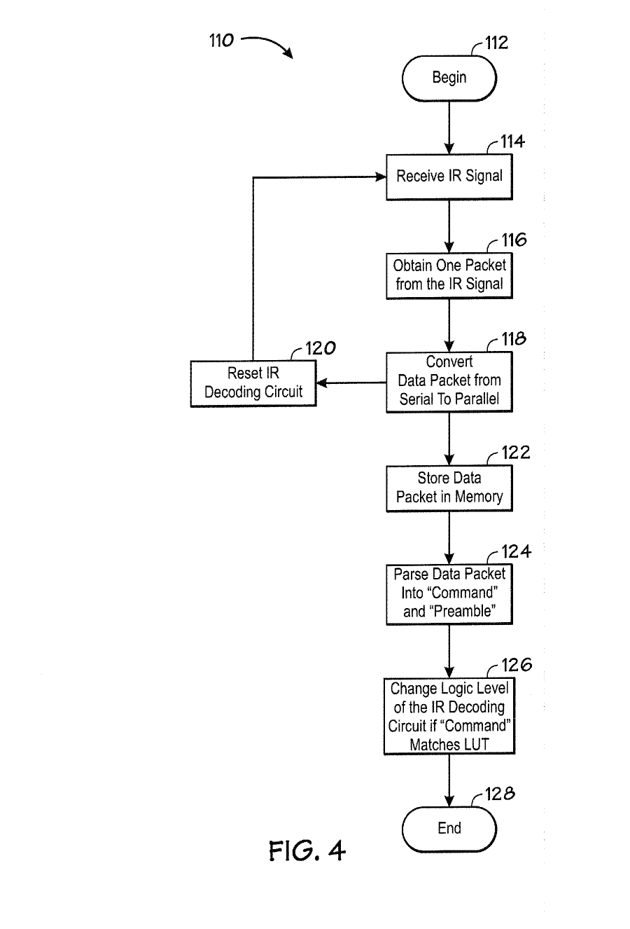

FIG. 4 is a flow chart of a method 110 of operation of an IR decoder in accordance with an exemplary embodiment of the present invention. The method described below is one which can be implemented using an IR decoding circuit, such as the one described above, configured to consume low amounts of power as required, for example, by the industry standard Energy Star when the electronic device is switched off. Accordingly, the method 110 may be implemented in FPGA IR decoding circuits, such circuits 50 and 70 of FIGS. 2 and 3, respectively.

The method 110 begins at block 112 and then proceeds to block 114 in which the electronic device operates in a low power mode and IR signals are received by the FPGA IR decoding circuit. Thereafter, the method 110 proceeds to block 116 whereby the FPGA IR decoding circuit extracts a single data packet from a plurality of data packets comprising the IR signal while discarding the remaining data packets. Next, at block 118 the single data packet is converted from a serial to a parallel form for further processing. From block 118, the method proceeds to blocks 120 and 122. At block 120, the IR decoding circuit is reset so as to enable certain elements of the IR decoding circuit utilizing the aforementioned functions in the above blocks of the method 110 to process subsequent IR signals and data packets received by the IR decoding circuit. Thus, from block 120 the method loops back to block 114.

In addition, at block 122 the data packet processed at block 118 is stored in a memory circuit. Subsequently at block 124, the data packet is parsed into a “preamble” portion and a “command” portion, whereby both portions are compared to predefined values stored on respective LUTs. For example, upon comparison of the “preamble” a signal is forwarded to the electronic device's main processor indicative of such a comparison. Next, at block 126 the “command” portion of the data packet is compared to predefined values stored on a LUT, which upon matching produces a signal changing the logic level of the IR decoding circuit. As a result, a relay drive is enabled so that the power supply of the electronic device is electrically connected to the electronic device's main processor. Accordingly, at this stage the electronic device is maintained at a high power mode, meaning the main processor acquires all IR decoding functionalities.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1. An electronic device configured to receive a control signal, comprising:
a first decoder configured to decode the control signal when the electronic device is operating in a first power mode; and
a second decoder configured to decode a first packet in the control signal and discard subsequent packets in the control signal when the electronic device is operating in a second power mode.

2. The electronic device of claim 1, wherein the electronic device comprises a television (TV), a digital versatile video recorders (DVDR), a computer, a video cassette recorders (VCR), a video camera, a personal digital assistant (PDA), or a cell phone.

3. The electronic device of claim 1, wherein the first decoder comprises a computer processing unit and the second decoder comprises a field programmable gate array (FPGA).

4. The electronic device of claim 1, wherein the second power mode is a low power mode compliant with an “Energy Star” industry standard.

5. The electronic device of claim 1, wherein the second decoder comprises a first comparator and a second comparator, wherein the first comparator is coupled to the first decoder and the second comparator is coupled to a relay drive, wherein the relay drive is configured to switch the electronic device between the first power mode and the second power mode.

6. The electronic device of claim 5, wherein the first comparator is configured to compare a preamble portion of the control signal to predefined values stored in a first comparator look-up table (LUT) and the second comparator is configured to compare a command portion of the IR signal to predefined values stored in a second comparator look-up table (LUT) to determine whether to switch the electronic device from the second power mode to the first power mode.

7. The electronic device of claim 1, wherein the first decoder and the second decoder are separated from one another.

8. The electronic device of claim 1, wherein the first power mode corresponds to a first logic state of the second decoder and the second power mode corresponds to a second logic state of the second decoder.

9. The electronic device of claim 1, comprising a reset circuit configured to reset the second decoder between consecutive decoding processes of the control signal.

10. The electronic device of claim 1, comprising a memory circuit configured to store the first data packet in the control signal.

11. The electronic device of claim 1, wherein the control signal comprises an infra-red (IR) signal.

12. A method for processing a control signal of an electronic device, comprising:
receiving the control signal;
decoding a first data packet contained within the control signal while discarding subsequent packets contained within the control signal;
separating the first data packet into a command portion and a preamble portion; and
changing a logic level of a decoding circuit if the command portion matches a predefined value.

13. The method of claim 12, comprising converting the first data packet from a serial form to a parallel form.

14. The method of claim 12, comprising resetting the decoding circuit after the first data packet is decoded.

15. The method of claim 12, wherein the logic level of the decoding circuit determines whether the decoding circuit is operating in a low power mode.

16. The method of claim 12, comprising storing the first data packet before the data packet is separated.

17. The method of claim 12, wherein the control signal comprises an infra-red (IR) signal.

18. An electronic device, comprising:
a computer processing unit configured to decode a control signal when the device is operating in a first power mode; and
a decoder configured to decode a first packet in the control signal and discard subsequent packets in the control signal when the electronic device is operating in a second power mode.

19. The electronic device of claim 18, comprising a display system, a sound system, a control system, a power supply, a photo detector, or a combination thereof.

20. The electronic device of claim 18, wherein the decoder comprises a field programmable gate array (FPGA).
